(19) United States
(12) Patent Application Publication
(10) Pub. No.: US 2025/0329146 A1
(43) Pub. Date: Oct. 23, 2025

(54) IMAGE PROCESSING APPARATUS, IMAGE PROCESSING SYSTEM, OUTPUT APPARATUS, IMAGE PROCESSING METHOD, AND RECORDING MEDIUM IN WHICH IMAGE PROCESSING PROGRAM IS RECORDED

(71) Applicant: Sharp Kabushiki Kaisha, Osaka (JP)

(72) Inventor: KOTA FURUSAWA, Osaka (JP)

(21) Appl. No.: 19/174,703

(22) Filed: Apr. 9, 2025

(30) Foreign Application Priority Data
Apr. 17, 2024 (JP) 2024-066470

(51) Int. Cl. G06V 10/774; G06V 10/24; G06V 10/72; G06V 30/146; G06V 30/244; G06V 30/414

(52) U.S. Cl. CPC G06V 10/774; G06V 10/242; G06V 10/72; G06V 30/1463; G06V 30/2455; G06V 30/414

(57) ABSTRACT

An image processing apparatus includes an acquisition processing unit that acquires character image data, and a generation processing unit that generates learning data by executing predetermined augmentation processing on the character image data. In a case where the character image data is a specific character, the generation processing unit generates learning data by executing, on the specific character, augmentation processing different from augmentation processing for character image data other than the specific character.

### INCORPORATION BY REFERENCE

This application is based upon and claims the benefit of priority from the corresponding Japanese Patent Application No. 2024-066470 filed on Apr. 17, 2024, the entire contents of which are incorporated herein by reference.

### BACKGROUND

The present disclosure relates to a technique for executing image processing such as character recognition on an image.

In the related art, a technique is known in which a character string is extracted from an image of paperwork such as a document or a business form. For example, a known technique generates learning data obtained by adding noise to an input image (data augmentation) in order to improve recognition accuracy for characters handwritten on a business form such as a receipt.

However, a problem with the known technique is that, for example, the augmented learning data adversely affects a specific character to reduce the recognition accuracy for the character. For example, when learning data is generated in which a background image of horizontal lines (underlines, ruled lines, or the like) is added to the number “7”, a problem in this case is that the input image “7” is erroneously recognized as “2” in a case where OCR processing is performed on the input image “7”.

### SUMMARY

An object of the present disclosure is to provide an image processing apparatus, an image processing system, an output apparatus, an image processing method, and a recording medium in which an image processing program is recorded that are capable of improving recognition accuracy for a specific character.

According to an aspect of the present disclosure, an information processing system includes an acquisition processing unit and a generation processing unit. The acquisition processing unit acquires character image data. The generation processing unit generates learning data by executing predetermined augmentation processing on the character image data. In a case where the character image data is a specific character, the generation processing unit generates the learning data by executing, on the specific character, augmentation processing different from augmentation processing for the character image data other than the specific character.

According to an aspect of the present disclosure, an image processing system includes the image processing apparatus and a learning apparatus that generates a learned model by performing machine learning using the learning data generated by the image processing apparatus.

According to another aspect of the present disclosure, an output apparatus executes character recognition processing on an input image using the learned model generated by the learning apparatus and outputs a character recognition result.

According to another aspect of the present disclosure, an image processing method executed by one or more processors includes acquiring character image data, generating learning data by executing predetermined augmentation processing on the character image data, and in a case where the character image data is a specific character, generating the learning data by executing, on the specific character, augmentation processing different from augmentation processing for the character image data other than the specific character.

According to another aspect of the present disclosure, a storage medium stores an image processing program for causing one or more processors to acquire character image data, to generate learning data by executing predetermined augmentation processing on the character image data, and in a case where the character image data is a specific character, to generate the learning data by executing, on the specific character, augmentation processing different from augmentation processing for the character image data other than the specific character.

According to the present disclosure, an image processing apparatus, an image processing system, an output apparatus, an image processing method, and a recording medium in which an image processing program is recorded can be provided that are capable of improving recognition accuracy for a specific character.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a configuration of an image processing system according to an embodiment of the present disclosure.

FIG. 2 is a diagram illustrating an example (receipt) of an input image according to an embodiment of the present disclosure.

FIG. 3A is a diagram illustrating an example (receipt) of an input image according to an embodiment of the present disclosure.

FIG. 3B is a diagram illustrating an example of a case where a character of an input image is erroneously recognized.

FIG. 3C is a diagram illustrating an example of a case where a character of an input image is erroneously recognized.

FIG. 4 is a flowchart illustrating an example of a procedure of learned model generation processing executed in an image processing apparatus according to an embodiment of the present disclosure.

### DETAILED DESCRIPTION

Embodiments of the disclosure will be described below with reference to the drawings. Note that the following embodiments are specific examples of the disclosure, and do not limit the technical scope of the disclosure.

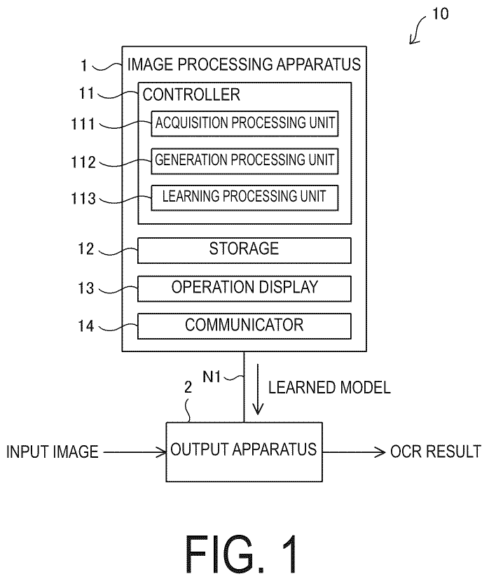

FIG. 1 is a block diagram illustrating a configuration of an image processing system 10 according to an embodiment of the present disclosure. The image processing system 10 includes an image processing apparatus 1 and an output apparatus 2. The image processing apparatus 1 performs processing of generating, as learning data (teacher data) used for machine learning, augmented data obtained by performing predetermined augmentation processing (data augmentation) on a learning image (character image data). The image processing apparatus 1 performs machine learning using the learning data to generate a learned model for performing character recognition on an input image. The output apparatus 2 executes an OCR result (character recognition processing) on an input image for character recognition using the learned model, and outputs the OCR result (character recognition result).

As illustrated in FIG. 1, the image processing apparatus 1 includes a controller 11, a storage 12, an operation display 13, a communicator 14, and the like. The image processing apparatus 1 may be one or more cloud servers or one or more physical servers.

The communicator 14 is a communication interface for connecting the image processing apparatus 1 to a network N1 in a wired or wireless manner and executing data communication with external equipment (for example, an output apparatus 2) via the network N1 in accordance with a predetermined communication protocol. The network N1 includes, for example, the Internet, a LAN, or the like.

The operation display 13 is a user interface including a display such as a liquid crystal display or an organic EL display that displays various types of information, and an operation unit such as a mouse, a keyboard, or a touch panel that receives an operation. For example, the operation display 13 receives an instruction to generate learning data (augmentation data) and displays a result of augmentation processing and the learning data.

The storage 12 is a non-volatile storage such as a hard disk drive (HDD), a solid state drive (SSD), or a flash memory that stores various types of information. The storage 12 stores a control program such as a learned model generation program (an example of an information processing program of the present disclosure) for causing the controller 11 to execute learned model generation processing described below. For example, the learned model generation program is non-temporarily recorded in a computer-readable recording medium such as a CD or a DVD, read by a reading apparatus (not illustrated) such as a CD drive or a DVD drive included in the image processing apparatus 1, and stored in the storage 12. Note that the learned model generation program may be distributed from a cloud server and stored in the storage 12.

The storage 12 stores image data (scan data or the like) of a document or the like acquired from external equipment.

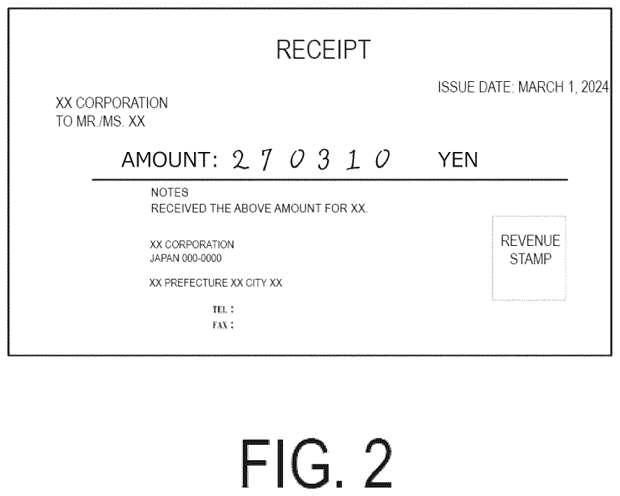

FIG. 2 illustrates a receipt as an example of the document. As illustrated in FIG. 2, the receipt includes multiple items such as an issue date, an address, contact information of an issuer, and an amount of money. The user uses external equipment to scan the receipt and upload image data (input image) to the image processing apparatus 1. Upon acquiring the image data of the receipt, the controller 11 stores the image data in the storage 12. As another embodiment, the controller 11 may acquire a document file of the receipt created in the external equipment and store the document file in the storage 12.

The controller 11 includes control equipment such as a central processing unit (CPU), a read only memory (ROM), and a random access memory (RAM). The CPU is a processor that executes various types of arithmetic processing. The ROM stores in advance control programs such as a BIOS and an OS for causing the CPU to execute various types of processing. The RAM stores various types of information and is used as a temporary storage memory (work area) for the various types of processing executed by the CPU. The controller 11 controls the image processing apparatus 1 by causing the CPU to execute various types of the control programs stored in advance in the ROM or the storage 12.

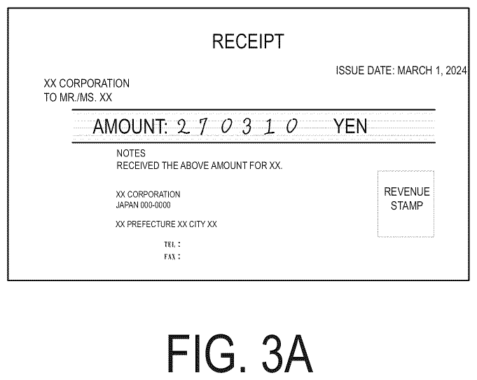

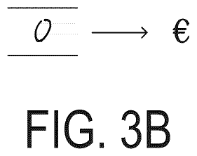

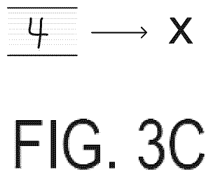

A problem with the known technique is that, for example, the augmented learning data adversely affects a specific character to reduce the recognition accuracy for the character. For example, when learning data (augmented data) is generated in which a background image of horizontal lines (underlines, ruled lines, or the like) is added to the number “7”, a problem in this case is that the input image “7” is erroneously recognized as “2” in a case where OCR processing is performed on the input image “7”. Specifically, when the receipt illustrated in FIG. 2 is subjected to the OCR processing in accordance with the known technique, the character of the amount “7” may be erroneously recognized as “2” or the character of the amount “1” may be erroneously recognized as “/(slash symbol)”. For example, when the OCR processing is performed on a receipt in which ruled lines are drawn in an amount field (see FIG. 3A), the character “0” of the amount may be erroneously recognized as a Euro symbol as illustrated in FIG. 3B. Further, when the OCR processing is performed on a receipt in which ruled lines are drawn in a date field, the number “4” may be erroneously recognized as a character for “X” as illustrated in FIG. 3C. As described above, the known technique poses a problem of reduced recognition accuracy for specific characters. On the other hand, the image processing apparatus 1 according to the present disclosure has a configuration capable of improving the recognition accuracy for the specific character as described below.

Specifically, as illustrated in FIG. 1, the controller 11 includes various processing units such as an acquisition processing unit 111, a generation processing unit 112, and a learning processing unit 113. Note that the controller 11 functions as the various processing units by executing various types of processing in accordance with the learned model generation program. Further, some or all of the processing units included in the controller 11 may be constituted by an electronic circuit. Note that the learned model generation program may be a program for causing multiple processing units to function as the various processors.

The acquisition processing unit 111 acquires a learning image (character image data). Specifically, the acquisition processing unit 111 acquires, from the external equipment, character image data, which is the original data of the learning data. For example, the acquisition processing unit 111 acquires character image data of various document images such as a receipt illustrated in FIGS. 2 and 3A.

The generation processing unit 112 generates learning data by executing predetermined augmentation processing on the character image data. Specifically, the generation processing unit 112 executes, on a character image of the character image data, augmentation processing such as synthesis processing of synthesizing the character image with a background image, rotation processing of rotating the character image, translation processing of translating the character image in horizontal and vertical directions, enlargement/reduction processing for the character image, shearing processing for the character image, inversion processing for inverting the character image in the horizontal and vertical directions, adjustment processing of adjusting brightness of the character image, gradation processing of changing RGB values of the character image, or scaling processing for the character image, to generate learning data (augmented data) subjected to the augmentation processing. As the augmentation processing according to the present embodiment, known augmentation processing can be applied. For example, the generation processing unit 112 generates learning data (augmented data) by executing at least one of the above-described augmentation processing operations on the character of the character image data.

Here, in a case where the character image data is the specific character, the generation processing unit 112 according to the present embodiment restricts execution of the predetermined augmentation processing. Specifically, in a case where the character image data is the specific character, the generation processing unit 112 generates learning data by executing, on the specific character, augmentation processing different from augmentation processing for the character image data other than the specific character.

For example, for the synthesis processing of synthesizing the specific character with a background image or the rotation processing of rotating the specific character, the generation processing unit 112 executes processing different from processing for the character image data other than the specific character.

In a case where the target character of the augmentation processing is a handwritten number, a date-related character (a number or a kanji character), or an amount-related character (a number or a kanji character), the generation processing unit 112 restricts execution of the predetermined augmentation processing. In a case where the target character of the augmentation processing does not correspond to any of these characters, the generation processing unit 112 executes the augmentation processing in the same manner as in the related art.

For example, when the number “7” is underlined, the number “7” tends to be erroneously recognized as the number “2”. Thus, in a case where the target character of the augmentation processing is the handwritten number “7”, the generation processing unit 112 does not execute the synthesis processing of synthesizing the character with the background image of underlines. Note that the background image is not limited to an image of underlines and that the generation processing unit 112 may be configured not to execute the synthesis processing of synthesizing the character with a background image including one or more horizontal lines. That is, for the handwritten number “7”, the generation processing unit 112 omits the synthesis processing of synthesizing the number with the background image of horizontal lines and generates learning data by executing another augmentation processing operation.

Similarly, for example, when a horizontal line is attached near the center of the number “0”, the number tends to be erroneously recognized as a Euro symbol (see FIG. 3B). Thus, when the target character of the augmentation processing is the handwritten number “0”, the generation processing unit 112 does not execute the synthesis processing of synthesizing the character with the background image of a horizontal line near the center of the character. Note that the background image is not limited to the image of a horizontal line near the center and the generation processing unit 112 may be configured not to execute the synthesis processing of synthesizing the character with a background image including one or more horizontal lines. That is, the generation processing unit 112 omits the synthesis processing of synthesizing the handwritten number “0” with the background image of horizontal lines and generates learning data by executing another augmentation processing operation.

For example, when a horizontal line is attached near the center of the number “4”, the numeral “4” tends to be erroneously recognized as the character for “X” (see FIG. 3C). Thus, when the target character of the augmentation processing is the handwritten number “4”, the generation processing unit 112 does not execute the synthesis processing of synthesizing the character with a background image of a horizontal line near the center of the character. Note that the background image is not limited to the image of a horizontal line near the center and the generation processing unit 112 may be configured not to execute the synthesis processing of synthesizing the character with a background image including one or more horizontal lines. That is, the generation processing unit 112 omits the synthesis processing of synthesizing the handwritten number “4” with the background image of horizontal lines, and generates learning data by executing another augmentation processing operation.

As another embodiment, the generation processing unit 112 may omit the synthesis processing of synthesizing the numbers “7” and “4” with the background image of underlines and execute the synthesis processing of synthesizing the numbers with the background image of a horizontal line near the center of the number, while omitting the synthesis processing of synthesizing the number “0” with the background image of a horizontal line near the center and executing the synthesis processing of synthesizing the number with the background image of underlines.

As described above, in a case where the character image data is the specific character including a linear portion, the generation processing unit 112 generates augmented data without executing the synthesis processing of synthesizing the character with a background image including a linear image.

For example, when having an inclination angle (in the case of an italic character), the number “1” tends to be erroneously recognized as “/(slash symbol)”. Thus, in a case where the target character of the augmentation processing is the handwritten number “1”, the generation processing unit 112 does not execute the rotation processing of rotating the character. As another embodiment, the generation processing unit 112 may set a lower limit value and an upper limit value of the rotation angle. For example, a larger inclination angle makes the number more likely to be erroneously recognized as a “/(slash symbol)” or a “-(hyphen)”, the generation processing unit 112 sets the upper limit value of the rotation angle of the number “1” to, for example, 3 degrees. In this case, the generation processing unit 112 generates one or more augmented data by rotating the number “1” in the range of 0 degrees to 3 degrees, and does not generate augmented data obtained by rotating the number “1” through more than 3 degrees.

Similarly, for example, for the numbers “4” and “6”, the generation processing unit 112 may generate one or more augmented data by rotating the number within a predetermined range. Here, the numbers “4” and “6” may be less likely to be erroneously recognized as “/(slash symbol)” than the number “1”. Thus, the generation processing unit 112 may set the upper limit value of the rotation angle of the numbers “4” and “6” larger than the upper limit value of the rotation angle of the number “1”. For example, for the numbers “4” and “6”, the generation processing unit 112 generates one or more augmented data by rotating the number in the range of, for example, 0 degrees to 15 degrees, and does not generate augmented data obtained by rotating the number through more than 15 degrees.

Note that, for the numbers other than the numbers “1”, “4”, and “6”, the generation processing unit 112 may generate one or more augmented data obtained by rotating the number in the range of, for example, 0 degrees to 30 degrees.

As described above, in a case where the character image data is the specific character including a linear portion, the generation processing unit 112 generates augmented data by executing the rotation processing within an angular range corresponding to the type of the specific character.

As described above, the generation processing unit 112 generates the augmented data by limiting the augmentation processing for the specific character. The generation processing unit 112 restricts the augmentation processing when the specific character is a handwritten character written as a predetermined item in a business form (for example, a receipt). For example, the generation processing unit 112 restricts the augmentation processing in a case where the specific character is a handwritten character written in the amount field or the date field of the business form. In a case where the specific character is not a handwritten character written in the amount field or the date field of the business form, the generation processing unit 112 executes augmentation processing similar to that executed in the related art. The generation processing unit 112 generates augmented data obtained by performing augmentation processing on character image data as learning data to be used for machine learning.

The learning processing unit 113 performs machine learning using the learning data to generate a learned model. Specifically, the learning processing unit 113 performs machine learning on the augmented data to generate the learned model.

Note that the machine learning involves algorithms such as supervised learning using supervised data, unsupervised learning using unsupervised data, and reinforcement learning. Further, in order to realize these techniques, a method called “deep learning” is used in which extraction of a feature amount itself is learned. In the present embodiment, the learning processing unit 113 has a learning model based on the various algorithms described above. By performing machine learning using supervised data and unsupervised data as input data, the learning processing unit 113 can generate a learned model that executes character recognition processing. That is, the image processing apparatus 1 functions as a learning apparatus that generates a learned model.

The learned model can be applied to various output apparatuses 2 (such as a character recognition apparatus). For example, as illustrated in FIG. 1, when an input image to be subjected to character recognition is input to the output apparatus 2 (such as a user terminal), the output apparatus 2 performs the OCR processing on the input image using the learned model to output an OCR result.

Specifically, the output apparatus 2 executes processing of extracting a character string rectangle from the input image and processing of extracting a single character rectangle for each handwritten character. The output apparatus 2 uses the learned model to execute the OCR processing on each of the extracted character string rectangle and single character rectangle, to output an OCR result (character recognition result). Well-known techniques can be applied to each processing in the output apparatus 2.

Here, the image processing apparatus 1 may acquire the OCR result and perform additional learning. Specifically, when the input image includes a special background to prevent characters from being recognized, the image processing apparatus 1 may perform additional learning on the background. For example, the generation processing unit 112 may omit the synthesis processing of synthesizing a character that cannot be recognized and the special background image. The learning processing unit 113 may perform additional machine learning for the special background image. In a case where the erroneously recognized background is a special character image, the input image from which pixels constituting the handwritten character are removed corresponds to the background when a portion of the input image having a pixel color different from that of the handwritten character is regarded as the background. By additionally learning the background, the image processing apparatus 1 can recognize even a special background.

Note that the learned model may be downloaded to the output apparatus 2 for use, or may be stored in a server (cloud server) and used by accessing the server from a user terminal via the Internet or the like. For example, when an arbitrary input image is input to the user terminal, the learned model outputs an optimal character recognition result.

### Learned Model Generation Processing

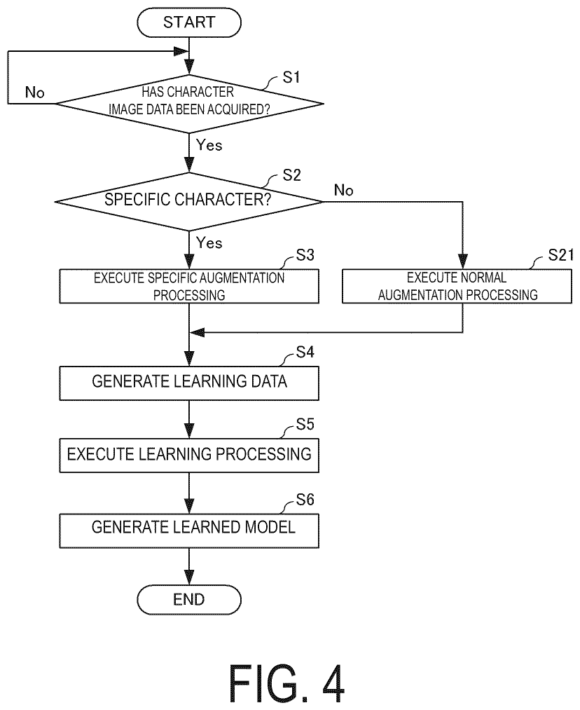

FIG. 4 is a flowchart illustrating an example of a procedure of learned model generation processing executed in the image processing apparatus 1.

Note that the present disclosure can be regarded as a learned model generation method (image processing method of the present disclosure) of executing one or more steps included in the learned model generation processing. One or more of the steps included in the learned model generation processing described herein may be omitted as appropriate. The steps of the learned model generation processing may be executed in a different order to the extent that similar effects are produced. Further, here, a case in which the controller 11 of the image processing apparatus 1 executes each of the steps of the learned model generation processing will be described as an example, but in another embodiment, one or more processors may execute the steps of the learned model generation processing in a distributed manner. When acquiring character image data (learning image) from external equipment, the controller 11 can execute the learned model generation processing in parallel for each character image data.

In step S1, the controller 11 determines whether character image data (learning image) has been acquired. Specifically, the controller 11 acquires character image data from external equipment or the like. Upon acquiring character image data (S1: Yes), the controller 11 transitions the processing to step S2. The controller 11 awaits until character image data is acquired (S1: No).

In step S2, the controller 11 determines whether the character image data is the specific character. Specifically, the controller 11 determines whether the character image data is a handwritten number, a date-related character (number, kanji character), or an amount-related character (number, kanji character). The controller 11 determines whether the character image data includes any of the numbers that is likely to be erroneously recognized (for example, “0”, “1”, “4”, “7”, or the like). Upon determining that the character image data is the specific character (S2: Yes), the controller 11 transitions the processing to step S3. On the other hand, in a case of determining that the character image data is not a specific character (S2: No), the controller 11 transitions the processing to step S21.

In step S3, the controller 11 executes specific augmentation processing on the specific character. For example, in a case where the specific character is a handwritten number “0”,“4”, or “7”, the controller 11 does not execute the synthesis processing of synthesizing the character image with a background image of underlines or a background image of multiple horizontal lines, but executes another type of augmentation processing (rotation processing, translation processing, enlargement/reduction processing, shearing processing, inversion processing, adjustment processing, gradation processing, scaling processing, or the like).

For example, in a case where the specific character is a handwritten number “1”, the controller 11 executes rotation processing within a predetermined angular range in the rotation processing for the character image. For example, the number “1” is rotated in the range of 0 degrees to 3 degrees.

On the other hand, in step S21, the controller 11 executes normal augmentation processing on the characters (normal characters) of the character image. For example, the controller 11 executes, on the character image, the synthesis processing, rotation processing, translation processing, enlargement/reduction processing, shearing processing, inversion processing, adjustment processing, gradation processing, scaling processing, or the like.

In step S4, the controller 11 generates learning data. Specifically, controller 11 generates, for the specific characters, augmented data obtained by executing the specific augmentation processing, and generates, for the normal characters, augmented data obtained by executing the normal augmentation processing.

In step S5, the controller 11 executes the learning processing. Specifically, the controller 11 performs machine learning using the augmented data. The controller 11 executes known learning processing such as deep learning.

In step S6, the controller 11 generates a learned model. Specifically, the controller 11 performs machine learning using the augmented data as input data to generate a learned model that executes character recognition processing.

The controller 11 generates the learned model as described above. The generated learned model is introduced into the output apparatus 2 (character recognition apparatus). Upon acquiring the input image for character recognition, the output apparatus 2 executes processing of extracting, from the input image, a character string rectangle and a single character rectangle for each handwritten character. The output apparatus 2 uses the learned model to execute the OCR processing on each of the extracted character string rectangle and single character rectangle, to output an OCR result (character recognition result).

As described above, the image processing apparatus 1 according to the present embodiment acquires character image data and generates learning data by executing the predetermined augmentation processing on the character image data. In a case where the character image data is the specific character, the image processing apparatus 1 generates the learning data by executing, on the specific character, augmentation processing different from augmentation processing for the character image data other than the specific character. For example, in a case where the character image data is the specific character including a linear portion, the image processing apparatus 1 generates the learning data without executing the synthesis processing of synthesizing the character image data with the background image including a linear image. For example, in a case where the character image data is the specific character including a linear portion, the image processing apparatus 1 generates the learning data by executing the rotation processing within an angular range corresponding to the type of the specific character.

According to the above-described configuration, for example, no augmented data is generated in which a background image of horizontal lines (underlines, ruled lines, or the like) is added to the number “7”, and thus erroneous recognition (for example, erroneous recognition as “2”) can be prevented that is caused by the augmented data. No augmented data is generated that is obtained by rotating the number “1” through more than 3 degrees, and thus erroneous recognition (for example, erroneous recognition as “/(slash symbol)” or “-(hyphen)”) can be prevented that is caused by the augmented data. Therefore, the recognition accuracy of the specific character can be improved.

Note that the augmentation processing different from the augmentation processing for the character image data other than the specific character is the synthesis processing or the rotation processing, but is not limited thereto, and may be the translation processing, the enlargement/reduction processing, the shearing processing, the inversion processing, the adjustment processing, the gradation processing, or the scaling processing described above.

Note that the specific character is not limited to the number or the kanji character, and may be an alphabet character, a Hangul character, a Chinese character, or the like. The specific character is not limited to a handwritten character written in the amount field or the date field, and may be a handwritten character written in an address field or a destination field. The business form is not limited to a receipt, and may be a quotation, a bill, a packing list, or the like.

In the image processing system 10, the image processing apparatus 1 and the output apparatus 2 may be configured as integrated equipment. The processing units (the acquisition processing unit 111, the generation processing unit 112, and the learning processing unit 113) of the image processing apparatus 1 may be arranged in multiple pieces of equipment in a distributed manner. For example, the learning processing unit 113 may be included in a piece of equipment (learning apparatus) different from the image processing apparatus 1. In this case, the image processing system 10 may include the image processing apparatus 1 and a learning apparatus that generates a learned model by performing machine learning using the learning data generated by the image processing apparatus 1.

### Supplementary Notes of Disclosure

Hereinafter, an outline of the disclosure extracted from the above-described embodiments will be described as supplementary notes. Note that configurations and processing functions described in the following supplementary notes can be selected and combined as desired.

### Supplementary Note 1

An image processing apparatus including:
an acquisition processing circuit that acquires character image data; and
a generation processing circuit that generates learning data by executing predetermined augmentation processing on the character image data, wherein
in a case where the character image data is a specific character, the generation processing circuit generates the learning data by executing, on the specific character, augmentation processing different from augmentation processing for the character image data other than the specific character.

### Supplementary Note 2

The image processing apparatus according to Supplementary Note 1, wherein
for synthesis processing of synthesizing the specific character with a background image or rotation processing of rotating the specific character, the generation processing circuit executes processing different from processing for the character image data other than the specific character.

### Supplementary Note 3

The image processing apparatus according to Supplementary Note 2, wherein
in a case where the character image data is the specific character including a linear portion, the generation processing circuit generates the learning data without executing the synthesis processing of synthesizing the specific character with a background image including a linear image.

### Supplementary Note 4

The image processing apparatus according to Supplementary Note 2 or 3, wherein
in a case where the character image data is the specific character including a linear portion, the generation processing circuit generates the learning data by executing the rotation processing within an angular range corresponding to a type of the specific character.

### Supplementary Note 5

The image processing apparatus according to any one of Supplementary Notes 1 to 4, wherein
the specific character is a handwritten character written as a predetermined item in a business form.

### Supplementary Note 6

The image processing apparatus according to Supplementary Note 5, wherein
the specific character is a handwritten character written in an amount field or a date field of the business form.

### Supplementary Note 7

The image processing apparatus according to any one of Supplementary Notes 1 to 6, wherein
the generation processing circuit generates, as the learning data used for machine learning, augmented data obtained by performing the augmentation processing on the character image data.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image processing apparatus comprising one or more processors, wherein
the one or more processors are configured to:
acquire character image data;
generate learning data by executing predetermined augmentation processing on the character image data; and
in a case where the character image data is a specific character, generate the learning data by executing, on the specific character, augmentation processing different from augmentation processing for the character image data other than the specific character.

2. The image processing apparatus according to claim 1, wherein
for synthesis processing of synthesizing the specific character with a background image or rotation processing of rotating the specific character, the one or more processors execute processing different from processing for the character image data other than the specific character.

3. The image processing apparatus according to claim 2, wherein
in a case where the character image data is the specific character including a linear portion, the one or more processors generate the learning data without executing the synthesis processing of synthesizing the specific character with a background image including a linear image.

4. The image processing apparatus according to claim 2, wherein
in a case where the character image data is the specific character including a linear portion, the one or more processors generate the learning data by executing the rotation processing within an angular range corresponding to a type of the specific character.

5. The image processing apparatus according to claim 1, wherein
the specific character is a handwritten character written as a predetermined item in a business form.

6. The image processing apparatus according to claim 5, wherein
the specific character is a handwritten character written in an amount field or a date field of the business form.

7. The image processing apparatus according to claim 1, wherein
the one or more processors generate, as the learning data used for machine learning, augmented data obtained by performing the augmentation processing on the character image data.

8. An image processing system comprising:
the image processing apparatus according to claim 7; and
a learning apparatus that generates a learned model by performing machine learning using the learning data generated by the image processing apparatus.

9. An output apparatus that executes character recognition processing on an input image using the learned model generated by the learning apparatus according to claim 8 and outputs a character recognition result.

10. An image processing method executed by one or more processors, the image processing method comprising:
acquiring character image data;
generating learning data by executing predetermined augmentation processing on the character image data; and
in a case where the character image data is a specific character, generating the learning data by executing, on the specific character, augmentation processing different from augmentation processing for the character image data other than the specific character.

11. A non-transitory computer-readable recording medium on which an image processing program is recorded, the image processing program causing one or more processors to:
acquire character image data;
generate learning data by executing predetermined augmentation processing on the character image data; and
in a case where the character image data is a specific character, generate the learning data by executing, on the specific character, augmentation processing different from augmentation processing for the character image data other than the specific character.
